(19) United States
(12) Patent Application Publication
(10) Pub. No.: US 2014/0250575 A1
(43) Pub. Date: Sep. 11, 2014

(54) ALTERNATE QUILTING

(71) Applicant: THE NORTH FACE APPAREL CORP., Wilmington, DE (US)

(72) Inventor: Luk Kin MAN, Hong Kong (HK)

(73) Assignee: THE NORTH FACE APPAREL CORP., Wilmington, DE (US)

(21) Appl. No.: 13/793,453

(22) Filed: Mar. 11, 2013

(51) Int. Cl. A41D 31/02; B32B 7/08; D05B 11/00

(52) U.S. Cl. CPC A41D 31/02; D05B 11/00; B32B 7/08
USPC 2/456; 112/117; 112/441

(57) ABSTRACT

An alternate quilting method and an apparatus manufactured by applying the alternate quilting method. Multiple layers may be arranged in layer sets, the layers of each layer set may be quilt-stitched to each other, and as a result, stitches may be formed. A space between the layers of each layer set may be filled with a thermal insulation material. The layer sets may be offset with respect to each other, in order for the stitches of one layer set to be blocked by the area of another layer set abundant with the insulation material, the objective of which may be to block flow of cold air through the alternate quilting construction.

### TECHNICAL FIELD

The present invention generally relates to a quilting method of stitching, which is applied for making a variety of garments or covers that can be used for preserving body heat in the environment of low temperature, indoors or outdoors.

### BACKGROUND

One of the most important features of quilted garments and covers is their thermal insulation capacity. In order for quilted clothing to protect against cold temperatures, it contains insulation material that either needs to be abundant, or that is expensive if it has natural heat preserving properties (e.g., down). Consequently, optimizing insulation efficiency of quilted clothing not only renders it warmer and more comfortable to wear, but also decreases the amount of the insulation material needed, and, thus, lowers the manufacturing cost of the quilted garment or the quilted cover.

Currently in the art, the two most common constructions used for manufacturing thermal insulation garments are the conventional quilting technique and the baffle technique. There is a need to improve insulation characteristics of clothes made by the existing techniques without increasing the amount of insulation materials that they use.

The conventional quilting method entails stitching a quilting line through an outer layer (shell) of a garment or a cover in order for the insulation material, e.g., down, to be contained. Normally, down is distributed unevenly throughout the garment. It is fuller and thicker in the middle of a quilted section and scarce at quilting stitches. As a result, thermal insulation of garments made by the conventional quilting becomes excessive and wasteful in the middle portion, and insufficient around the stitches, where undesirable cold spots are formed.

The baffle technique is developed to address this problem, but it only covers some, and not all cold spots. This technique attaches sections of a garment or a cover to each other over a two-dimensional interface inserted at the stitches level, and the second dimension of the interface that the baffle technique introduces is intended to block the flow of cold air at the stitches, i.e., between the sections. Though, clothing objects manufactured by the baffle technique still provide ineffective thermal insulation, because they inevitably allow the cold air to penetrate through them laterally. For example, a front and a back panel of a baffle-made jacket are sewn to each other in the lateral portion of the jacket, and, as a result, the lateral seams create substantial and uncomfortable cold spots.

Accordingly, there is a need for an alternate quilting technique which can be used for manufacturing warm garments and covers with a minimal amount of thermal insulation material and with no cold spots.

### SUMMARY

One aspect of the present invention relates to alternate quilting method of stitching, used for making an apparatus that may preserve body heat in a low-temperature environment. One example of such an apparatus may include a plurality of layers parallel to each other, which may be arranged in at least two layer sets, and where each of the at least two layer sets may include at least two layers that may be quilt-stitched to each other, and a thermal insulation material, which may occupy a space between the at least two layers of each of the at least two layer sets, where the at least two layer sets may be offset relative to each other.

Each of the at least two layer sets may further include a plurality of stitches, which may function to quilt-stitch the at least two layers of each of the at least two layer sets to each other. Moreover, each of the plurality of stitches of each of the at least two layer sets may be aligned with an area between the plurality of stitches of each other of the at least two layer sets. Further, each of the plurality of stitches of each of the at least two layer sets may be aligned with an area mid-way between the plurality of stitches of each other of the at least two layer sets. The at least two layer sets may be separated by an air space portion.

In one embodiment, the plurality of stitches of each of the at least two layer sets may be spaced farther apart from each other than the plurality of stitches of each other of the at least two layer sets.

In another embodiment, a thickness of each of the at least two layer sets may be different than a thickness of each other of the at least two layer sets.

In one example of the current invention, the thermal insulation material that may occupy the space between the at least two layers of each of the at least two layer sets may also be distinct from the thermal insulation material that may occupy the space between the at least two layers of each other of the at least two layer sets. Further, the thermal insulation material may be one of the following: down, poly-fill, and fiber ball.

Another aspect of the present invention relates to a method of quilting, which may include placing a plurality of layers parallel to each other and arranging the plurality of layers in at least two layer sets, where each of the at least two layer sets may include at least two layers, then filling a space between the at least two layers with a thermal insulation material, quilt-stitching the at least two layers to each other, and, finally, offsetting the at least two layer sets relative to each other.

The method may further include using a plurality of stitches to quilt-stitch the at least two layers of each of the at least two layer sets to each other, and aligning each of the plurality of stitches of each of the at least two layer sets with an area between the plurality of stitches of each other of the at least two layer sets.

One aspect of the present invention relates to quilting method of stitching, used for making a variety of garments or covers that may preserve body heat in a cold environment. One example of such a garment may include a plurality of layers parallel to each other, where the plurality of layers may be arranged in at least two layer sets, and where each of the at least two layer sets may include at least two layers that may be quilt-stitched to each other, and a thermal insulation material, which may occupy a space between the at least two layers of each of the at least two layer sets, where the at least two layer sets may be offset relative to each other. The at least two layer sets may be offset relative to each other in at least two directions, more specifically, in the horizontal and in the lateral direction.

Each of the at least two layer sets may further include a plurality of stitches, which may function to quilt-stitch the at least two layers of each of the at least two layer sets to each other. Moreover, each of the plurality of stitches of each of the at least two layer sets may be aligned with an area between the plurality of stitches of each other of the at least two layer sets. Further, the at least two layer sets may be separated by an air space portion.

In addition, the plurality of stitches of each of the at least two layer sets may be spaced farther apart from each other than the plurality of stitches of each other of the at least two layer sets. In one example, a thickness of each of the at least two layer sets may be different than a thickness of each other of the at least two layer sets. In another example, the thermal insulation material that may occupy the space between the at least two layers of each of the at least two layer sets may be distinct from the thermal insulation material that may occupy the space between the at least two layers of each other of the at least two layer sets. Finally, the thermal insulation material may be one of the following: down, poly-fill, and fiber ball.

### BRIEF DESCRIPTION OF THE DRAWINGS

The present invention will become more fully understood from the detailed description given below and from the accompanying drawings. The drawings are intended to disclose but a few possible examples of the present invention, and thus do not limit the present invention's scope.

FIG. 1A shows one example of alternate quilting where join stitches of adjacent layer sets are offset with respect to each other;

FIG. 1B shows one example of alternate quilt blocking flow of air between layer sets;

FIG. 1C shows one example of alternate quilting where join stitches of adjacent layer sets are offset with respect to each other in two perpendicular directions;

FIG. 2A shows a detailed description of one example of an alternate quilting and a conventional quilting construction used for mutual comparison;

FIG. 2B shows results of comparison of insulation capabilities between one example of an alternate quilting and a conventional quilting construction;

FIG. 3 shows one example of a garment manufactured by alternate quilting;

FIG. 4 shows one example of a garment manufactured by alternate quilting where join stitches of inner and outer layer sets are horizontally and laterally offset with respect to each other;

FIG. 5 shows one example of alternate quilting, where quilt sections vary in width, thickness and insulation material used.

### DETAILED DESCRIPTION

The present invention generally relates to a quilting method of stitching applied for making a variety of garments or covers, which can be used for preserving body heat in the environment of low temperature, indoors or outdoors. While a preferred example of alternate quilting is described in detail below, a construction in accordance with the present invention may be used in a broad range of products, such as indoor and outdoor garments, as well a variety of covers, comforters, and other apparel and accessories.

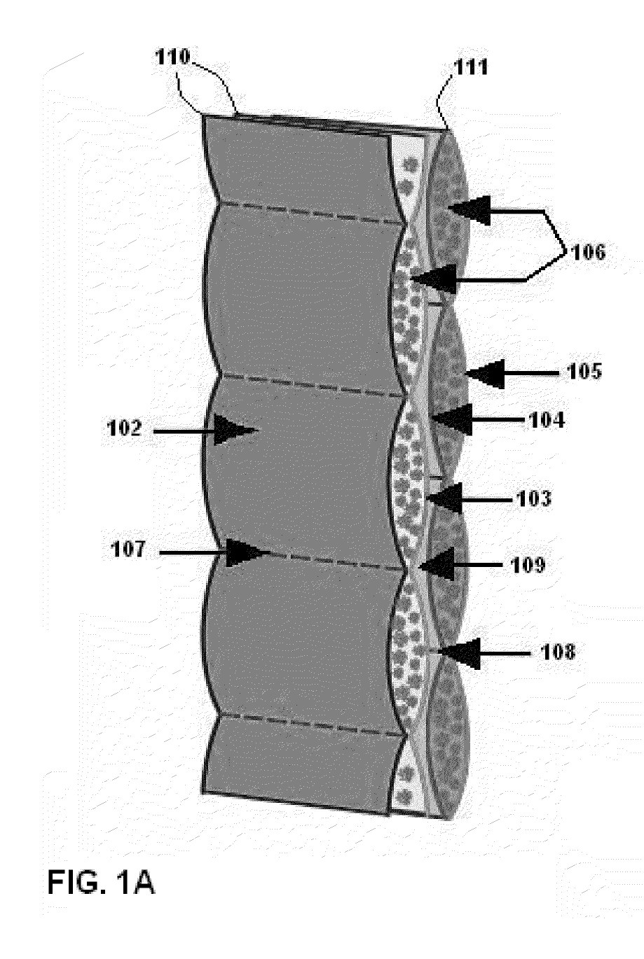

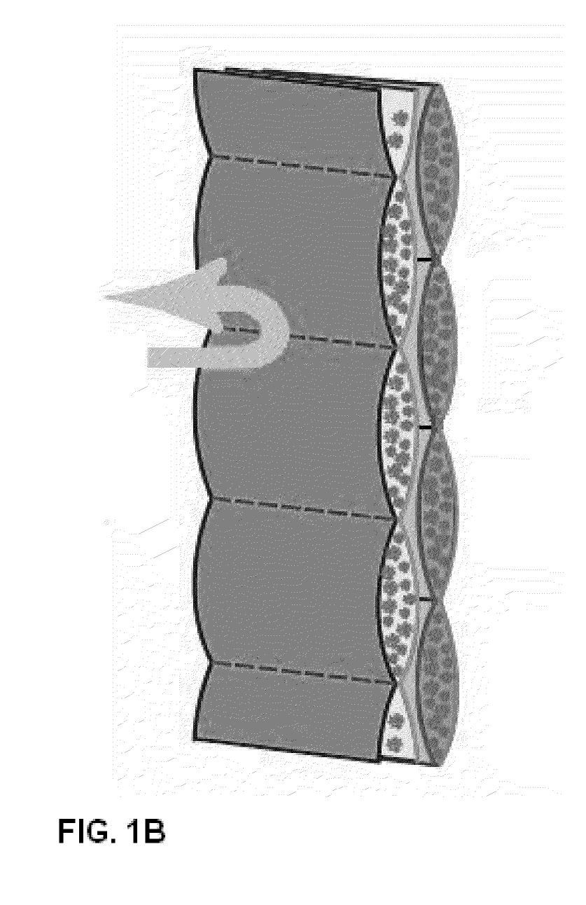

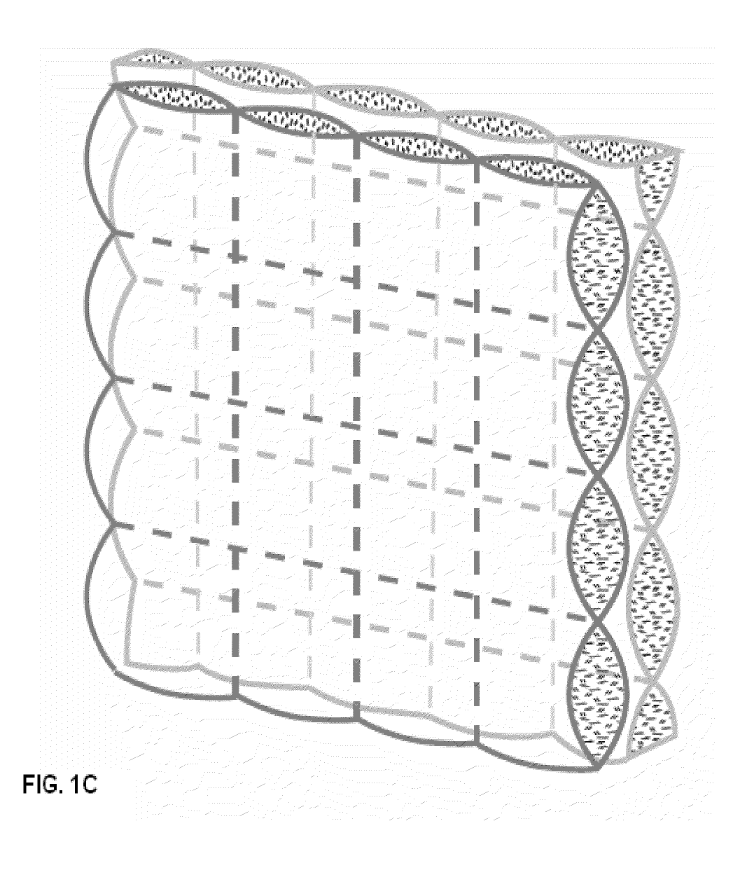

One example of alternate quilting in accordance with the present invention is shown in FIG. 1A. An alternate quilting method may include forming four layers parallel to each other: shell layer 102, outer interlining 103, inner interlining 104 and lining 105. As illustrated in FIG. 1A, the shell layer 102 may be positioned to be the outer layer, i.e. the farthest one from a body of a user, and it may be adjacent to the outer interlining 103. The outer interlining 103 may be quilt-stitched to the shell layer 102 and the space between these two layers may be occupied with insulation material 106, which may be held by outer stitches 107. The thermal insulating material 106 may be distributed so that it is abundant in the area mid-way between the outer stitches 107, and thin near the outer stitches 107.

Turning to the other two layers of the alternate quilting technique, lining 105 may be positioned to be the inner layer, i.e. the closest one to a body of a user, and it may be adjacent to the inner interlining 104. The inner interlining 104 may be quilted to the lining 105 and the space between these two layers may be occupied with insulation material 106, which may be held by inner stitches 108. The insulation material 106 may be distributed so that it is abundant in the area mid-way between the inner stitches 108, and thin near the inner stitches 108.

Further, air space portion 109 may separate outer layer set 110, which may include the shell layer 102 and the outer interlining 103, from inner layer set 111, which may include the inner interlining 104 and the lining 105. Considering that air is inherently a poor heat conductor, the air space portion 109 between the two layer sets may trap air for additional insulation.

The outer layer set 110 and the inner layer set 111 may be offset relative to each other. The outer stitches 107 of the outer layer set 110 may be aligned with the area mid-way between the inner stitches 108 of the inner layer set 111, which may, in turn, align the inner stitches 108 of the inner layer set 111 with the area mid-way between the outer stitches 107 of the outer layer set 110.

This feature constitutes a significant improvement over the conventional quilting, because, as shown in FIG. 1B, the alternate quilting construction blocks potential paths of cold air penetrating through stitches of one layer set by meeting the cold air with an area of the other set that is abundant with the thermal insulating material 106.

Further, in one example, illustrated in FIG. 1C, the layers may be stitched together so that the stitches are produced in two directions perpendicular to each other, for example, in a vertical and a horizontal direction, on each layer set. In this example, the stitches of different layer sets may be offset in both the vertical and the horizontal direction. Consequently, this pattern may eliminate all of the potential cold spots of a garment or a cover manufactured by the alternate quilting technique.

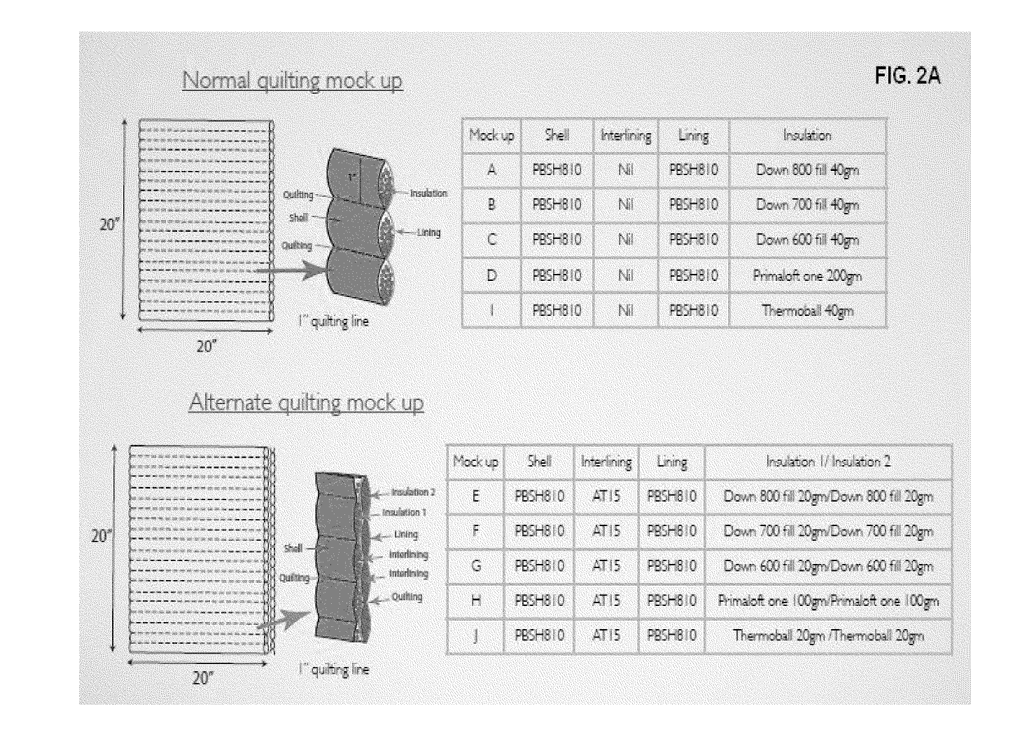

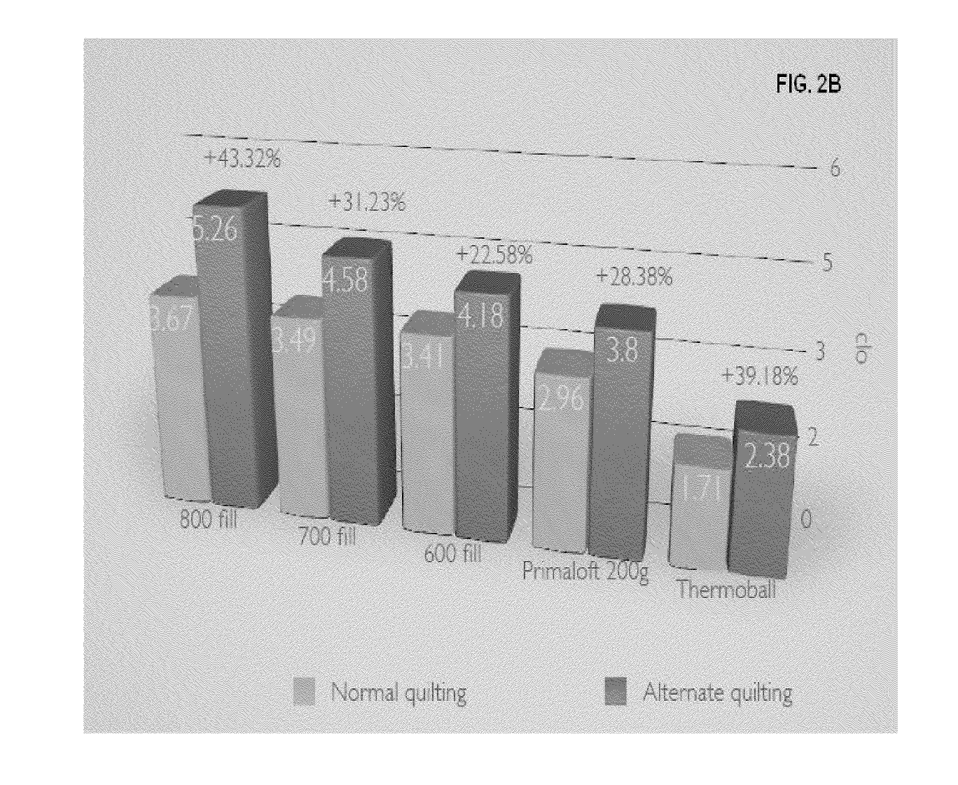

After conducting numerous experiments, the above-named inventor determined that the alternate quilting arrangement improves the overall insulation capacity in comparison with a conventional quilt, as shown in FIG. 2B. The comparison was conducted with three different insulation materials: down, primaloft and thermoball, as presented in FIG. 2A. The thickness of the primaloft of both the alternate and the conventional constructions was selected to be 200 gm, and the thickness of the thermoball was 40 gm. While the thickness of the down was set at 40 gm, the density of the down was gradually varied to be 800 fill, 700 fill and 600 fill.

As depicted in FIG. 2B, the alternate quilting construction made with down resulted in a substantial improvement in insulation capacity over the conventional construction, varying from 22.58-43.32% enhancement, depending on the density of the down. Similarly, the alternate construction made with either the primaloft or the thermoball also produced a significantly better insulation capacity compared to the conventional construction, resulting in 28.38% and 39.18% improvement, respectively. The outcome of the presented experiment indicates that even with a variety of densities of different insulation materials, the alternate quilting consistently performs better than other quilting techniques available in the art.

One embodiment of this invention may also substantially improve distribution of the insulating material 106 and, consequently, decrease consumption of expensive natural insulators (e.g., down) that are commonly used for manufacturing bed covers, or winter clothing. Namely, the excessive and wasteful down used in the art to fill the portion of one layer set mid-way between the stitches may now be reduced, and the deducted amount of down may be used for insulation in another, offset, layer set. The reduction in down would not diminish the overall thermal insulation capacity of the garment or the cover made by alternate quilting. On the contrary, because the two layer sets may be offset relative to each other, the cold spots around the stitches may be eliminated, thereby preventing the body heat from escaping through them. Consequently, by re-distributing the insulation material, the alternate quilting technique may decrease overall cost of material necessary for quilted garments or covers.

Moreover, by increasing the number of layers used, the alternate quilting technique may enhance the aesthetic options of a garment or a cover. Namely, the conventional quilting technique uses an inner lining layer primarily for containing the insulation material, and not for its visual or tactile appeal. In one embodiment of this invention, the shell layer 102 and the lining 105 may be interchangeable, and the outer interlining 103 and the inner interlining 104 may function to hold the insulation material 106. Thus, by swapping the two arrangements of the four layer construction, inside-out relative to each other, the shell layer 102 and the lining 105 may alternate as being the outer and the inner layer of the garment or the cover. Thereby, the alternate quilting construction may provide two independent aesthetic appearances of the same garment or cover, based on a user's preference to expose either the shell layer 102 or the lining 105 as the most outer layer.

Moreover, it is known in the art that, instead of directly stitching two layers into a layer set, a two-dimensional interface can be inserted at the stitches between adjacent layers in order to provide a buffer between them and create room for insulating material to fall across the buffer interface and block the flow of cold air. As a result, the insulating material is contained by a three-dimensional baffle-like construction, and thus, in the art this quilting technique is commonly referred to as the baffle technique. Nevertheless, while the baffle technique assembles baffle-like sections into panels, e.g., a front panel and a back panel, such panels can be laterally joined only by being directly sewn to each other. As explained above, the seams create cold spots and hinder insulating capacity of a garment manufactured by the baffle technique.

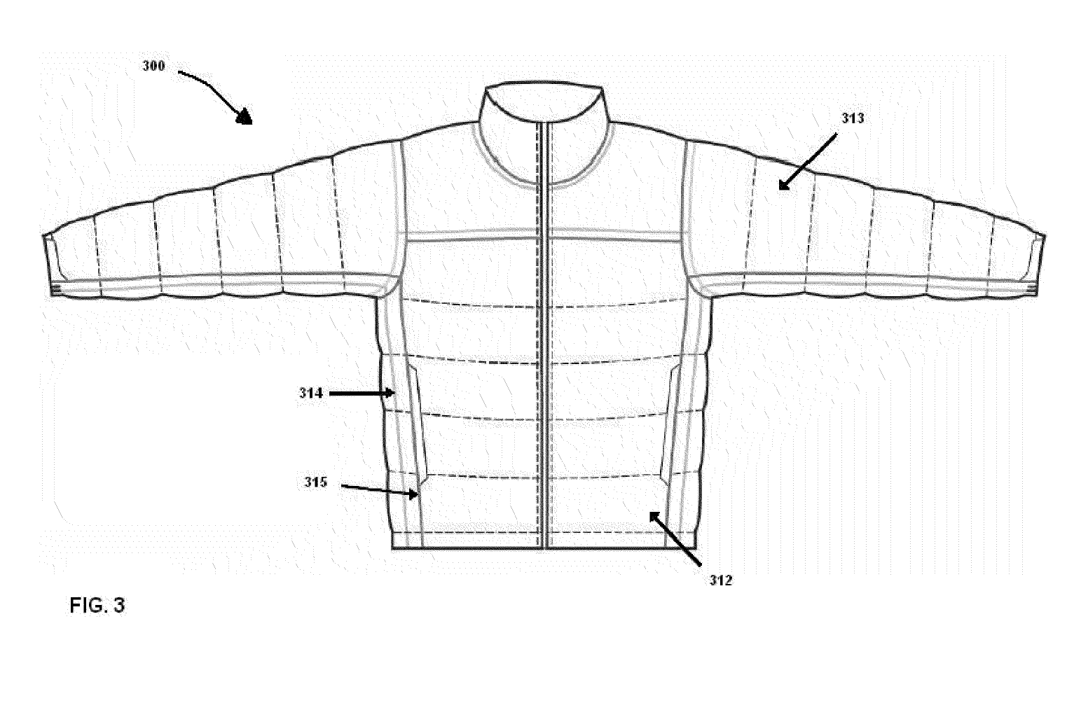

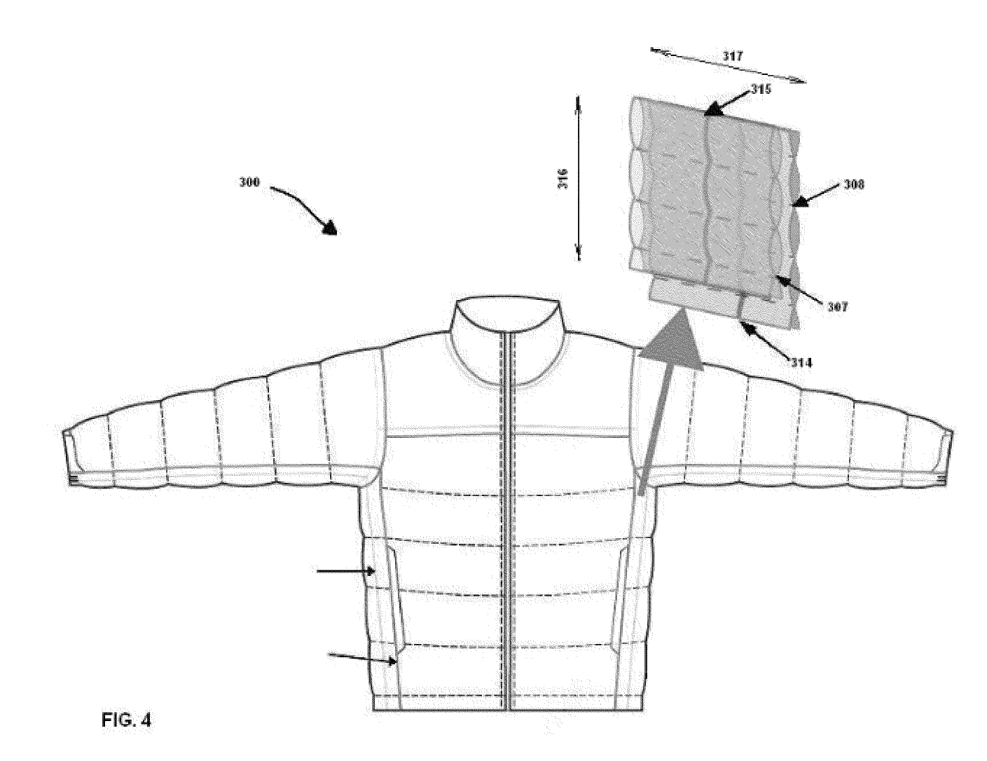

One example of the alternate quilting technique, shown in FIGS. 3 and 4, solves this issue by offsetting layer sets both horizontally and vertically (i.e., laterally).

As illustrated in FIG. 3, garment 300 may include two layer sets: an outer layer set and an inner layer set. Both layer sets may be constructed by quilting of torso area 312 and of sleeve area 313 thereby forming a front panel and a back panel of each of the two layers. Next, the front panel and the back panel of the outer layer set may be sewn to each other laterally, forming outer lateral seam 315. Similarly, the front panel and the back panel of the inner layer set may also be laterally sewn to each other, and inner lateral seam 314 may be created as a result.

The inner layer set and the outer layer set may be offset relative to each other in order to avoid formation of cold spots in either horizontal or lateral direction, as depicted enlarged in FIG. 4. Outer horizontal stitches 307 of the outer layer set may be aligned with the area mid-way between the inner horizontal stitches 308 of the inner layer set, which may, in turn, align the inner horizontal stitches 308 of the inner layer set with the area mid-way between the outer horizontal stitches 307 of the outer layer set. Next, outer lateral seam 315 of the outer layer set may also be offset relative to the inner lateral seam 314 of the inner layer set.

Therefore, in this example of the present invention, the potential paths of cold air penetrating through seams or stitches of one layer set may be blocked by another layer set, due to the fact that they may be offset with respect to each other in two directions: first, in direction 316, perpendicular to the horizontal stitches, and second, in direction 317, perpendicular to the lateral seams, as indicated in the enlarged portion of FIG. 4. Consequently, every individual stitch of one layer set may be aligned with an area of the other layer set abundant with thermal insulation material, and all the potential cold spots of the garment may be eliminated.

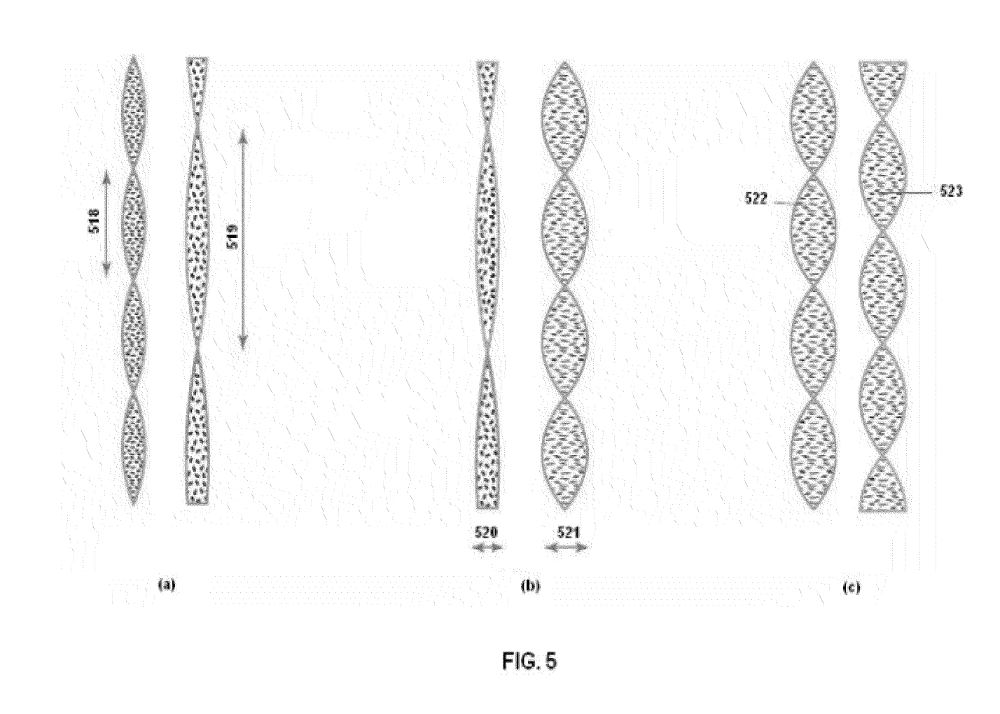

Moreover, in one embodiment of this invention the alternate quilting construction may constitute two layer sets, where the stitches of one layer set may be spaced farther apart from each other than the stitches of the other layer set, as shown in FIG. 5(a). Thus, width 518 of the quilted sections of one layer set may be different from width 519 of the quilted sections of the other layer set.

In another embodiment, in addition to difference in width of quilted sections, the thickness 520 of one layer set may be different from the thickness 521 of the other layer set, as shown in FIG. 5(b).

In both examples depicted in FIGS. 5(a) and 5(b), even though the widths of quilted sections of the two layer sets may be different, the stitches of one layer set may be positioned to be offset with the stitches of the other layer set in order for any path of cold air running straight through both layer sets to be blocked. In such manner both embodiments may prevent creation of cold spots.

In yet another example of this invention, illustrated in FIG. 5(c), one layer set may be filled with insulation material 522, which may be distinct from insulation material 523 of the other layer set. Non-limiting examples of materials for either one of the two insulation materials include down, poly-fill, fiber ball insulation, or any other material deemed suitable for effective body heat preservation.

These variations, combined with the feature of interchangeability between the external and internal layer sets, may enhance the diversity of aesthetic options that alternate quilting provides. Varying width of quilted sections may results in two distinct appearances and visual appeals of the same garment manufactured by alternate quilting. Moreover, changing the thickness of the layer sets may present a user with two different tactile feels of the same garment or the same cover, depending on which one of the two sides the user selects as the outer one. Finally, the virtually countless combinations of the layer set thickness and the insulation material of the alternate quilting technique allow for a broad range of adjustments with respect to insulating capabilities and manufacturing expanses of the end product.

While various embodiments have been described, other embodiments are plausible. It should be understood that the foregoing descriptions of various examples of alternate quilting are not intended to be limiting, and any number of modifications, combinations, and alternatives of the examples may be employed.

The examples described herein are merely illustrative, as numerous other embodiments may be implemented without departing from the spirit and scope of the present invention. Moreover, while certain features of the invention may be described above only in the context of certain examples or configurations, these features may be exchanged, added, and removed from and between the various embodiments or configurations while remaining within the scope of the invention.

We claim:

1. An apparatus, comprising:
a plurality of layers parallel to each other, wherein the plurality of layers are arranged in at least two layer sets; wherein each of the at least two layer sets includes at least two layers that are quilt-stitched to each other; and
a thermal insulation material, wherein the thermal insulation material occupies a space between the at least two layers of each of the at least two layer sets;
wherein the at least two layer sets are offset relative to each other.

2. The apparatus of claim 1, wherein each of the at least two layer sets includes a plurality of stitches;
wherein the plurality of stitches function to quilt-stitch the at least two layers of each of the at least two layer sets to each other; and
wherein each of the plurality of stitches of each of the at least two layer sets is aligned with an area between the plurality of stitches of each other of the at least two layer sets.

3. The apparatus of claim 1, wherein each of the plurality of stitches of each of the at least two layer sets is aligned with an area mid-way between the plurality of stitches of each other of the at least two layer sets.

4. The apparatus of claim 1, wherein the at least two layer sets are separated by an air space portion.

5. The apparatus of claim 2, wherein the plurality of stitches of each of the at least two layer sets are spaced farther apart from each other than the plurality of stitches of each other of the at least two layer sets.

6. The apparatus of claim 1, wherein a thickness of each of the at least two layer sets is different than a thickness of each other of the at least two layer sets.

7. The apparatus of claim 1, wherein the thermal insulation material that occupies the space between the at least two layers of each of the at least two layer sets is distinct from the thermal insulation material that occupies the space between the at least two layers of each other of the at least two layer sets.

8. The apparatus of claim 1, wherein the thermal insulation material is one of the following: down, poly-fill, and fiber ball.

9. A method of quilting, comprising:
placing a plurality of layers parallel to each other;
arranging the plurality of layers in at least two layer sets, wherein each of the at least two layer sets includes at least two layers;
filling a space between the at least two layers of each of the at least two layer sets with a thermal insulation material;
quilt-stitching the at least two layers of each of the at least two layer sets to each other; and
offsetting the at least two layer sets relative to each other.

10. The method of quilting of claim 9, further comprising using a plurality of stitches to quilt-stitch the at least two layers of each of the at least two layer sets to each other.

11. The method of quilting of claim 10, further comprising aligning each of the plurality of stitches of each of the at least two layer sets with an area between the plurality of stitches of each other of the at least two layer sets.

12. A garment, comprising:
a plurality of layers parallel to each other, wherein the plurality of layers are arranged in at least two layer sets; wherein each of the at least two layer sets includes at least two layers that are quilt-stitched to each other; and
a thermal insulation material, wherein the thermal insulation material occupies a space between the at least two layers of each of the at least two layer sets;
wherein the at least two layer sets are offset relative to each other.

13. The garment of claim 12, wherein the at least two layer sets are offset relative to each other in at least two directions.

14. The garment of claim 13, wherein the at least two layer sets are offset relative to each other in the horizontal and in the lateral direction.

15. The garment of claim 12, wherein each of the at least two layer sets includes a plurality of stitches;
wherein the plurality of stitches function to quilt-stitch the at least two layers of each of the at least two layer sets to each other; and
wherein each of the plurality of stitches of each of the at least two layer sets is aligned with an area between the plurality of stitches of each other of the at least two layer sets.

16. The garment of claim 12, wherein the at least two layer sets are separated by an air space portion.

17. The garment of claim 15, wherein the plurality of stitches of each of the at least two layer sets are spaced farther apart from each other than the plurality of stitches of each other of the at least two layer sets.

18. The garment of claim 12, wherein a thickness of each of the at least two layer sets is different than a thickness of each other of the at least two layer sets.

19. The garment of claim 12, wherein the thermal insulation material that occupies the space between the at least two layers of each of the at least two layer sets is distinct from the thermal insulation material that occupies the space between the at least two layers of each other of the at least two layer sets.

20. The garment of claim 12, wherein the thermal insulation material is one of the following: down, poly-fill, and fiber ball.
